(19) United States
(12) Patent Application Publication
(10) Pub. No.: US 2021/0153710 A1
(43) Pub. Date: May 27, 2021

(54) SYSTEM WITH AT LEAST TWO AUTOMATICALLY MOVING FLOOR PROCESSING DEVICES AS WELL AS A METHOD FOR OPERATING A SYSTEM

(71) Applicant: Vorwerk & Co. Interholding GmbH, Wuppertal (DE)

(72) Inventors: Andrej MOSEBACH, Unna (DE); Marc PAPENHEIM, Wuppertal (DE); Henning HAYN, Hilden (DE)

(73) Assignee: Vorwerk & Co. Interholding GmbH, Wuppertal (DE)

(21) Appl. No.: 16/953,672

(22) Filed: Nov. 20, 2020

(30) Foreign Application Priority Data
Nov. 22, 2019 (DE) 10 2019 131 583.2

(51) Int. Cl. A47L 11/40; A47L 9/28; A47L 11/10; A47L 11/24; A47L 11/28; G05D 1/02

(52) U.S. Cl. CPC A47L 11/4011; G05D 2201/0203; A47L 9/2852; A47L 9/2894; A47L 11/10; A47L 11/24; A47L 11/28; A47L 11/4066; A47L 9/2826; G05D 1/0291; G05D 1/0219; A47L 2201/04; A47L 2201/06; G05D 2201/0215; A47L 9/2847

(57) ABSTRACT

A system has at least two automatically moving floor processing devices, a shared computing device and a shared database, which stores an area map with several partial surface areas and a planned operational activity. A partial area designation and/or a floor type designation is stored. The computing device receives a floor processing command from a user, which indicates a floor processing activity to be performed, and having a partial area designation and/or a floor type designation. The computing device is set up to ascertain partial surface areas that correspond to the partial area designation and/or floor type designation specified in the floor processing command, and according to predefined rules, plan the performance of the floor processing activity specified in the floor processing command. The rules depend on a device parameter of the floor processing device and a position of the partial surface area in the environment to be processed.

### CROSS REFERENCE TO RELATED APPLICATIONS

Applicant claims priority under 35 U.S.C. § 119 of German Application No. 10 2019 131 583.2 filed Nov. 22, 2019, the disclosure of which is incorporated by reference.

### BACKGROUND OF THE INVENTION

### 1. Field of the Invention

The invention relates to a system with at least two automatically moving floor processing devices for the automatically controlled processing of a surface in an environment, a shared computing device allocated to the floor processing devices, which plans at least one operational activity of at least one floor processing device based on defined rules, and a shared database allocated to the floor processing devices, which stores an area map with several partial surface areas and the planned operational activity.

In addition, the invention relates to a method for operating such a system.

### 2. Description of the Related Art

Automatically moving floor processing devices are known in prior art, for example as vacuuming robots, mopping robots, polishing robots, or others. For example, the floor processing devices have cleaning elements, such as brushes, mopping elements, polishing elements, sanding elements, or the like. Further known in prior art is to automatically steer floor processing devices, so as to perform floor processing activities in which the floor processing device processes a surface.

It is further known to use several automatically moving floor processing devices within a system, wherein the system further provides a shared computing device along with a shared database for the floor processing devices.

DE 10 2017 113 288 A1 (also published as US 2018/0361569 A1) discloses a system with several floor processing devices for the automatically controlled processing of a surface, wherein a shared database allocated to the floor processing devices has operational activities planned according to defined rules for the floor processing devices. The operational activities are automatically planned by a central computing device of the system, for example as a function of a contamination of a partial area of a surface detected by a floor processing device.

### SUMMARY OF THE INVENTION

Proceeding from the aforementioned prior art, the object of the invention is to create a system with at least two independently moving floor processing devices, as well as a shared computing device and database allocated to the shared computing device, which can also consider individual queries by a user relative to a floor processing activity.

This object is achieved by storing a partial area designation and/or a floor type designation associated with the partial surface areas, wherein the computing device is set up to receive a floor processing command from a user of the system, with this floor processing command on the one hand indicating a floor processing activity to be performed, and on the other hand having a partial area designation and/or a floor type designation, wherein the computing device is set up to ascertain partial surface areas out of the plurality of partial surface areas contained in the area map that correspond to the partial area designation and/or floor type designation specified in the floor processing command, and according to predefined rules to plan the execution of the floor processing activity specified in the floor processing command by at least one floor processing device, wherein the rules depend on a device parameter of the floor processing device and a position of the partial surface area in the environment to be processed.

According to the invention, the system is thus designed to receive an individual floor processing command of a user, and analyze it relative to a desired floor processing activity in a defined partial surface area in the environment. For this purpose, the computing device of the system is designed to check the floor processing command for partial area designations and/or floor type designations contained therein as well as the indicated floor processing activity. To this end, the computing device compares the partial area designations and floor type designations stored in the database with the content of the floor processing command. If one or more correlations are found, the computing device determines which of the partial surface areas recorded in the area map have the respective partial area designation or floor type. The computing device then plans the floor processing activity requested by the user by means of the floor processing command for those partial surface areas that have the mentioned partial area designation and/or contain the designated floor type. The computing device plans the floor processing activity by selecting one or several floor processing devices of the system, wherein the selection takes place according to predefined rules, which depend on the device parameters of the available floor processing devices on the one hand, and on a location of the partial floor area to be processed on the other. The floor processing devices interconnected in the system are thus controlled by commands issued by a user based on various parameters. The computing device uses a mathematical algorithm to determine one or several floor processing devices best suited for a floor processing activity to be performed, wherein the computing device includes such a floor processing device in the plans for performing a floor processing activity, whose device parameter and position is optimal relative to the position of the partial surface area to be processed. Several floor processing devices can be planned for performing the floor processing activity, which are given a specific priority for performing the floor processing activity. The computing device can set a prioritization that first plans for an optimally suitable floor processing device, and in order of priority thereafter additional floor processing devices with device parameters and/or positions that are less optimal, e.g., for successfully performing the floor processing activity, than those of the floor processing device with a higher priority that was first prioritized. Those floor processing devices of the system having a lower prioritization than the floor processing device mentioned first can be provided for cases in which the favored floor processing device is not available, for example because it became stuck while performing the floor processing activity or is currently performing another activity. Regardless of a prioritization of several floor processing devices for performing the same floor processing activity, a chronological order of priority of the floor processing devices can be established for floor processing activities to be performed one after the other, wherein a first floor processing device performs a floor processing activity to be executed first, and a second floor processing device only finds application some time thereafter, so as to either continue the floor processing activity or perform an ensuing floor processing activity.

Within the meaning of the invention, a partial area designation is understood as a name for a specific partial surface area in the environment, for example which can correspond to a specific room designation in a home, e.g., living room, bedroom, hallway, but also fireplace area, dog corner, children's play area or the like. The partial surface areas do not have to correspond to entire rooms of a floorplan. Corresponding partial areas of a room are also partial surface areas that can likewise be given a partial area designation. For example, a floor type designation within the meaning of the invention includes an indication of whether a partial surface area has a hard floor, carpeted floor, or carpet. In addition, the floor types can be subdivided even further, in particular into long-pile carpeted floors, short-pile carpeted floors, tile floors, wood floors, laminate, cork floors, PVC and others. Floor processing activities within the meaning of the invention can include vacuuming, sweeping, mopping, polishing, sanding, oiling, impregnating, or others.

In particular, it is proposed that the floor processing command expressed by the user be a request comprised of several words, in particular a voice command, wherein the computing device is set up to derive from the floor processing command the indicated floor processing activity on the one hand, and the partial area designation and/or the floor type designation on the other, and possibly also a point in time relating to the floor processing operation. The user of the system according to the invention can transmit a floor processing command to the computing device in writing or orally. To this end, for example, the system can have a voice recognition software that can receive and analyze the floor processing command. Alternatively or additionally, the system can also have a user interface that is suitable for receiving a written floor processing command from the user. For example, the system can contain a mobile terminal of the user, in particular a mobile telephone, a tablet computer, a laptop or the like, by means of which the user can transmit the floor processing command. The components of the system, specifically the floor processing devices, the computing device, the database, and possibly also a terminal for receiving the floor processing command of the user are preferably interconnected within a wireless communications network, for example within a WLAN. The floor processing command of the user contains words combined into a request, which designate a partial area and/or a floor type to be processed on the one hand, and a floor processing activity on the other. The computing device, for example using a parser, breaks the floor processing command down into the constituents partial area designation and/or floor type designation and floor processing activity, so as to be able to plan a desired floor processing activity to be performed by at least one floor processing device of the system. If the user now transmits a voice command or text input to the computing device of the system, for example the “vacuum the kitchen” request, the computing device of the system determines the partial area designation “kitchen” on the one hand, and the floor processing activity “vacuum” on the other. The computing device then determines which floor processing device, or possibly which floor processing devices, are optimally suited for processing this partial surface area. In addition, the floor processing command of the user can also contain a time specification, in particular a point in time, at which the floor processing is to start or end. The user can basically also transmit other information via the floor processing command, for example a desired floor processing intensity, floor processing duration, or others.

It is proposed that the device parameter of the floor processing device be a floor processing element designed for a defined floor processing activity, a device variable, a charge status of an accumulator, a power level of an electric motor, a storage capacity of a collection container and/or a range, traveling speed or climbing ability of the floor processing device. For purposes of planning the floor processing devices present in the system for performing the floor processing activity desired by the user, consideration is thus given to properties of the floor processing devices that are rooted in particular in the type of respective floor processing device. On the one hand, this includes exterior properties of the floor processing device, for example the size, width, height, shape, ground clearance, and weight of the floor processing device. However, the device parameters can also be the parameters of cleaning elements that make up components of the floor processing device, for example floor processing elements such as cleaning brushes, mopping elements, polishing attachments, or the like. In addition, consideration can be given to the properties of an accumulator, in particular a charge status of the accumulator, or a power level of an electric motor. With respect to floor processing devices designed as vacuum cleaners, a device parameter can be a maximum storage capacity of a collection container for suction material, a current fill level of the collection container, a filter element, or the like. In addition, special capabilities of the floor processing device are also of interest, for example a range of the floor processing device owing to a charge status of an accumulator, a climbing ability of the floor processing device, a traveling speed of the floor processing device, or others.

In addition, it can be provided that the floor processing device specified for performing the floor processing activity be selected as a function of a distance and/or a height difference between the location of the partial surface area to be processed and a current position of the floor processing device. The height difference between the target location and current location of the floor processing device can be caused by different floors of a building, i.e., when the floor processing device moving toward the target has to overcome a building floor or even a landing, or the like. In selecting a suitable floor processing device for the floor processing activity to be performed, consideration is thus given to the position of the floor processing device in relation to the position of the partial surface area to be processed, for example to include whether basically suitable floor processing devices are positioned on the same coherent height level as the partial surface area, or whether these alternatively are able to overcome a height difference. For example, floor processing devices located on a different floor of a building than the partial surface area to be processed can basically perform this floor processing activity, but are unable to overcome the height difference, and can therefore not be included in the plan for performing the floor processing activity.

It is therefore achieved overall that one or several floor processing devices, which can be identical or different, are allocated for processing one or several partial surface areas. During allocation, consideration is given to device parameters on the one hand, but also to environmental parameters on the other. For example, device properties include characteristic configurations of the floor processing device that are especially suitable for performing a specific floor processing activity. The environmental parameters include the distance between the floor processing device and the desired partial surface area to be processed. An order of priority for the floor processing devices for processing the same partial surface area is established based on an algorithm implemented by the computing device, wherein wishes of the user relating to the starting time, ending time, or even a duration of floor processing can be considered. A partial surface area can optionally be divided into sub-areas, to which various floor processing devices can be allocated. For example, such a division can take place if one and the same room, for example a living room, has a hard floor on the one hand, and carpets lying on the hard floor on the other. The sub-areas can have allocated to them various floor processing activities, for example dry cleaning, wet cleaning, above-floor cleaning, or the like. In selecting a suitable floor processing device for performing a floor processing activity, consideration can also be given to a current position of the user; for example, use can preferably be made of those floor processing devices that are especially quiet within the partial surface area where the user is located at the time. A current location of the user can here be determined by a detection unit of a floor processing device, for example, or also based on a signal from a mobile terminal of the user.

It can be provided that the database of the system have information about the partial surface areas of the environment. The information about the partial surface areas can here in particular be a partial area designation, floor information relating to a floor of a building having the partial surface area, a floor type designation and/or a surface size of the partial surface area. The partial area designation can be a conventional designation of a room in the environment, for example living room, bathroom, hallway, bedroom, children's room, or the like. It is alternatively also possible that the partial area designation be a room number, an invented name, a number-word combination, or the like. For example, floor information can be broken down into cellar, ground floor, first floor, second floor, and the like. As already explained above, a floor type designation can be a designation such as hard floor, carpeted floor, carpet, or even finer divisions such as long-pile carpeted floor, short-pile carpeted floor, and the like. A surface size of the partial surface area can denote an area in square meters or other units, or alternatively an allocation to a specific surface area range, for example, e.g., 0 to 20 m², 20 to 40 m², 40 to 60 m², or other allocations.

It is further proposed that the database also contain contamination information about of the partial surface area and/or a time specification for a floor processing activity performed last in the partial surface area and/or a time specification for a planned floor processing activity and/or an estimated performance timespan for performing a floor processing activity and/or information about the type of floor processing activity allocated to the partial surface area. As a consequence, the database contains data about a contamination level of a specific partial area, for example. For example, this contamination level can be a percentage indication of 0 to 100%, which can be divided into large or small ranges. In addition, the database can also contain the proposed time indications, which the computing device can consider while including a floor processing device in plans for an upcoming floor processing activity. In addition, the database also contains information about a type of floor processing activity allocated to a specific partial surface area. For example, both the type “dry cleaning” and the type “wet cleaning” are allocated to a hard floor, while only the option “dry cleaning” is available for a carpeted floor, possibly divided into “gentle cleaning” or “intensive cleaning”.

The proposed database can further contain one or several floor processing activities chronologically planned in advance for one or several floor processing devices and allocated to the partial surface areas. The planned floor processing activities entered into the database describe the result of the computing device, specifically information about the floor processing device or the floor processing devices which were allocated as optimal to a specific partial surface area for a specific floor processing activity. The planned floor processing activities can here have a chronological sequence for a specific partial surface area, which determines the floor processing activities by starting times or at least in relation to a chronological order of priority.

It is further proposed that the computing device be set up to allocate the floor processing device to a partial surface area based upon a ratio determined according to mathematical methods, which indicates a suitability of the floor processing device for performing the floor processing activity in the partial surface area. The computing device uses a sorting algorithm, which determines a processing of a specific partial surface area of the environment by one or more floor processing devices. An order of processing priority can here also be determined for several floor processing devices. The algorithm is based upon defined rules for selecting suitable floor processing devices, whose rules among other things can determine, for example, that a floor processing device can only be used for a defined floor processing activity on a defined partial surface area if a path exists along which the floor processing device can move toward it. For example, such a traversable path does not exist if the partial surface area and the floor processing device are located on different floors of the building, and the floor processing device is unable to climb up the stairs and/or take an elevator, in addition to which no other system installations, for example drones, hoists, or the like, exist that can convey the floor processing device. In addition, the floor processing devices are sorted by the type of floor processing activity they can perform, wherein no floor processing devices are considered for a specific floor processing activity to be performed that cannot satisfy a specification relative to the type of floor processing. In addition, the floor processing devices are sorted based on their current distance from the partial surface area to be processed, and possibly also on the size of the partial surface area to be processed, the processing intensity it requires, which in particular can depend on a contamination level, for example. In addition, the floor processing devices can also be sorted by other parameters, for example a current charge status of an accumulator or the like. In summation, the floor processing devices are thus sorted depending on the properties of the floor processing devices, and also on the external circumstances in the environment. As a result, the computing device then determines a ratio that indicates a suitability of the specific floor processing device for a specific floor processing activity in a specific partial surface area. It can here be provided that a lowest possible ratio defines a better suitability than a comparatively higher ratio.

In addition, the invention proposes a method for operating a system, which is configured as explained above. The features and advantages described above in relation to the system here apply accordingly. In order to avoid repetition, reference is here made to the statements about the described system in relation to the method according to the invention.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a system according to the invention,

FIG. 2 is an area map of an environment to be processed,

FIG. 3 is a table with information about partial surface areas of the environment, and

FIGS. 4a-e are changes in the table shown on FIG. 3.

### DETAILED DESCRIPTION OF PREFERRED EMBODIMENTS

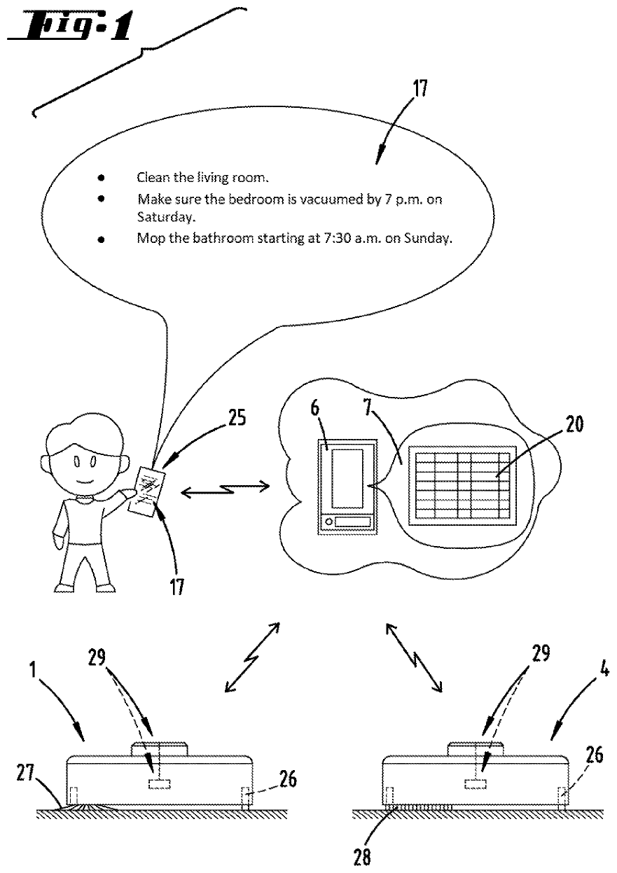

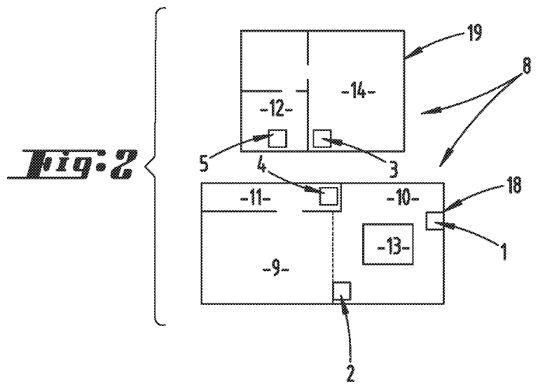

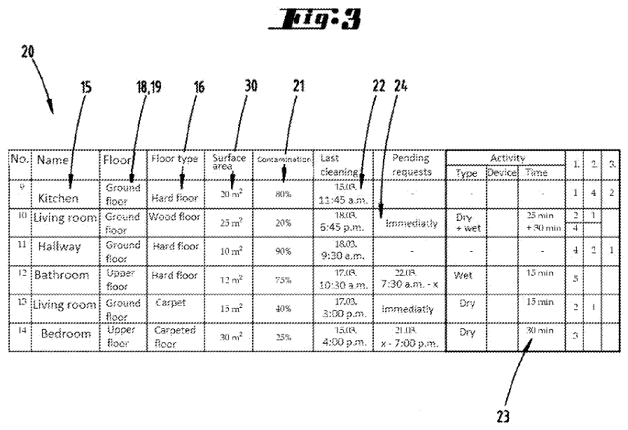

FIG. 1 shows a system with two exemplarily depicted floor processing devices 1, 4, representatively for other possible floor processing devices 1 to 5 (see FIG. 2). For example, the floor processing device 1 is an automatically moving vacuuming robot, while the floor processing device 4 is an automatically moving mopping robot. The floor processing devices 1 to 5 have wheels 26 for automatically moving, which are driven by a drive system not shown in any more detail. Depending on the device type of the floor processing device 1 to 5, each floor processing device 1 to 5 has different floor processing elements. In the case at hand, this is a rotating brush 27 for the floor processing devices 1, as well as a preferably oscillating mopping element 28 for the floor processing device 4. The floor processing devices 1 to 5 each have a local memory (not shown), which stores an area map 8 of the environment. The floor processing device 1 to 5 can orient itself and self-localize while automatically moving in the environment based on the area map 8. The floor processing devices 1 to 5 each have an undepicted, rechargeable accumulator for supplying power to the individual electrical consumers of the floor processing devices 1 to 5, for example for the drive system.

In addition, the floor processing devices 1 to 5 are each equipped with a navigation and self-localization system 29. The navigation and self-localization system 29 has a detection unit, for example a laser distance measuring device, which can measure distances to objects in the environment. For example, the detection unit has a laser diode, whose emitted light beam is guided out of a housing of the floor processing device 1 to 5, and can be rotated around an axis of rotation that is situated perpendicular in the depicted orientation of the floor processing device. In particular, this allows an all-round distance measurement around the floor processing device 1 to 5. The detection unit can be used to measure the environment in a preferably horizontal plane, i.e., in a plane parallel to the surface to be processed. As a result, the floor processing device 1 to 5 can travel in the environment while avoiding collisions with obstacles. The environmental data recorded by means of the detection unit are used for generating an area map 8 only exemplarily shown on FIG. 2. For example, the floor processing device 1 to 5 can additionally have an odometry sensor (not shown) for navigation and self-localization, which measures a distance covered by the floor processing device 1 to 5. In addition, it is also possible for the floor processing device 1 to 5 to have one or several contact sensors or the like, for example.

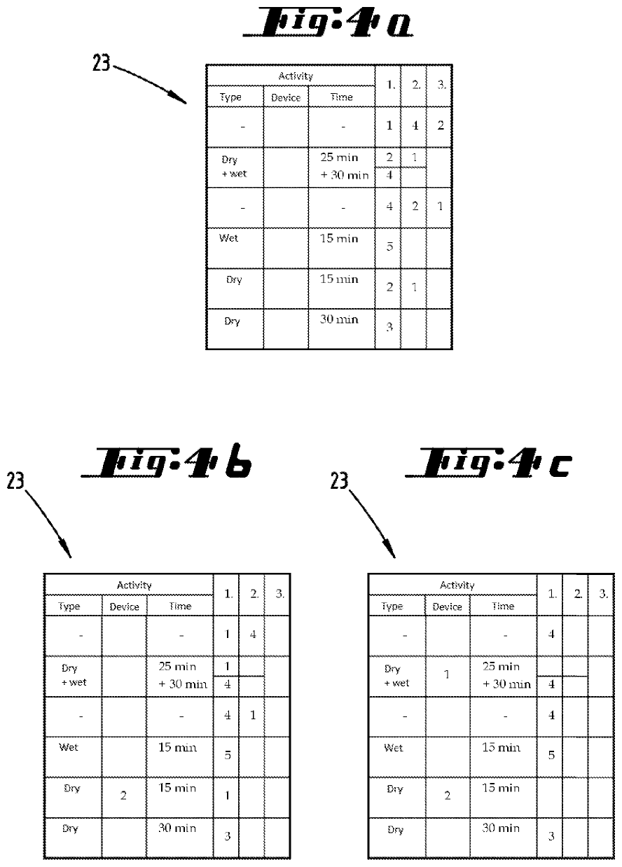

The floor processing devices 1 to 5 are here communicatively connected via a wireless communications link, preferably WLAN, with a central computing device 6, for example which is here located in a so-called cloud. The computing device 6 has allocated to it a database 7, which contains a Table 20 to be described in even more detail later with reference to FIG. 3. Participants in the wireless communication network further include a mobile terminal 25 of a user as well, for example which here is a mobile phone that has an application installed on it. The user can transmit floor processing commands 17 for one or several of the floor processing devices 1 to 5 via the terminal 25. For example, the user here voices three floor processing commands 17 in all, specifically “clean the living room”, “make sure the bedroom is vacuumed on Saturday by 7 p.m.”, and “mop the bathroom on Sunday starting at 7:30 a.m.”. The floor processing commands 17 of the user contain requests for processing partial surface areas 9 to 14 in the environment, here for example the “living room”, “bedroom” and “bathroom”, as well as the type of floor processing activity to be performed, here specifically “clean”, “vacuum” and “mop”. Depending on the type of floor covering of the respective partial surface area 9 to 14 to be processed, the “clean” floor processing activity can here comprise a dry cleaning and/or a mop cleaning. In this regard, the floor processing command 17 “clean” is more general than the requests “vacuum” and “mop”. If the type of floor covering basically allows both floor processing activities in the partial surface area 9 to 14, both vacuuming and mopping are performed according to the present embodiment.

Based on the floor processing commands 17 of the user, the computing device 6 formulates a plan for the floor processing activities, which are logged in the database 7, specifically Table 20. While moving, the floor processing devices 1 to 5 access a shared area map 8 (see FIG. 2), which preferably is also stored in the central computing device 6, and is generated based upon the local maps of the individual floor processing devices 1 to 5.

FIG. 2 shows the shared area map 8 that is available to the floor processing devices 1 to 5 in the database 7. For example, the shared area map 8 here forms two different floors 18, 19 of a house, wherein floor 18 relates to a ground floor, and floor 19 to an upper floor. Located on the floors 18, 19 are a plurality of partial surface areas 9 to 14, which correspond to rooms on the floors 18, 19 on the one hand, but on the other hand can also be areas of rooms. Subdivision by means of the computing device 6 takes place into sensible partial surface areas 9 to 14, which relate to partial areas with a floor covering to be varyingly processed, here for example a hard floor, wood floor, carpeted floor, and carpet. The depicted area map 8 marks the positions of five floor processing devices 1 to 5 in all, wherein the floor processing devices 1, 2, 3 are vacuuming robots, and the floor processing devices 4 and 5 are mopping robots. For example, the partial surface areas 9 to 14 are a kitchen as partial surface area 9, a wood floor of a living room as partial surface area 10, a hallway as partial surface area 11, a bathroom as partial surface area 12, a carpet of the living room as partial surface area 13, and a bedroom as partial surface area 14. The partial surface areas 9 to 14 of the area map 8 were previously acquired by the individual floor processing devices 1 to 5 and combined into the shared area map 8, wherein the current positions of the floor processing devices 1 to 5 are recorded in the area map 8. If a floor processing device 1 to 5 is selected for a floor processing activity, the sensor data of the respective floor processing device 1 to 5 can be compared with the data of the area map 8. If the data are approximately the same, the floor processing device 1 to 5 is actually in the position shown on the area map 8.

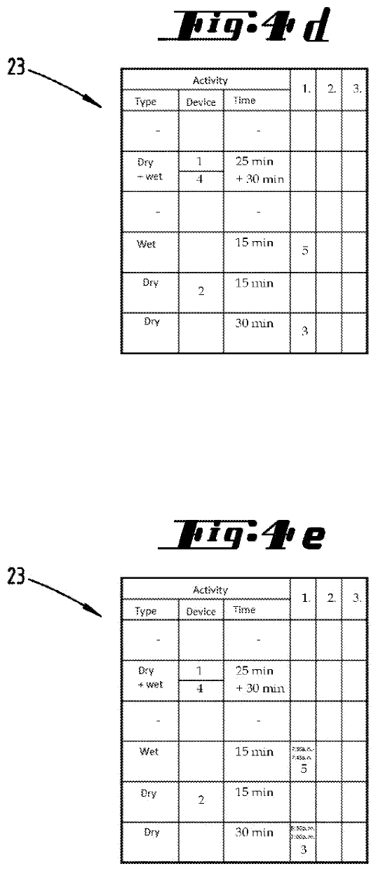

FIG. 3 shows the Table 20 stored in the database 7 in detail, which has in-depth information about the partial surface areas 9 to 14 of the environment. The information is in part automatically taken from the area map 8 by the computing device 6, and in part manually transmitted by the user to the computing device 6 via the terminal 25. The computing device 6 then completes Table 20 accordingly. Table 20 specifically contains a plurality of columns, which each contain various properties of the partial surface areas 9 to 14, as well as planned floor processing activities to be performed by the floor processing devices 1 to 5. Going from left to right, the exemplarily depicted Table 20 shows the numeration used here for the individual partial surface areas 9 to 14 in the first column. The column “name” contains partial area designations 15 for the partial surface areas 9 to 14 of the area map 8, here specifically the partial area designations 15 “kitchen”, “living room”, “hallway”, “bathroom”, and “bedroom”. Other names are of course also conceivable, for example the partial area designation 15 need not correspond to a room designation, but for example can also define a sub-area of a room, e.g., “fireplace area”, “dog corner”, and the like. The column “floor” indicates the floor 18, 19 on which the partial surface area 9 to 14 is located, here the floor 18 “ground floor” and the floor 19 “upper floor”. The column “floor type” contains a floor type designation 16 for the floor type present in the respective partial surface area 9 to 14, for example differentiated into “hard floor”, “wood floor”, “carpet”, and “carpeted floor”. The hard floors include a tile floor, for example. Wood floors here have their own floor type designation 16, since they are to be treated differently than tile floors in terms of moisture. The floor types “carpet” and “carpeted floor” likewise differ from each other, since as opposed to permanently installed carpeted floors, carpets can have the property of being moved around by a floor processing device 1 to 5, in particular if the carpet is especially light or small. The column “surface” contains surface information 30 about the size of the considered partial surface area 9 to 14. The surface information 30 is here indicated in square meters. Of course, the indication can also be given in different units. A division into categories such as “small”, “medium” and “large” could also take place. The column “contamination” contains contamination information 21 regarding the extent to which the respective partial surface area 9 to 14 has been contaminated. The contamination information 21 is here indicated as a percentage of a contamination defined as maximal. A contamination level of 0% here corresponds to an optimally cleaned partial surface area 9 to 14, while a contamination of 100% corresponds to a maximum possible contamination defined as such. The column “last cleaning” contains a time specification 22, which provides information as to when the respective partial surface area 9 to 14 was cleaned last. The time specification 22 here contains a date and time of day. The column “pending requests” contains a time specification 24 that defines the planned time of a floor processing activity. If a user has already transmitted one or several floor processing commands 17 to the computing device 6, the planned dates for floor processing activities are entered in this column, specifically the indication “immediately” for floor processing activities to which the user has allocated no definite performance time, and the indication of a date and/or time of day for floor processing commands 17 of the user that contain a concrete date and/or a concrete time of day. The floor processing commands 17 voiced by the user relative to the partial surface area 12 “bathroom” and the partial surface area 14 “bedroom” are correspondingly entered in the table with time specifications 24. The columns presented on the right next to the column “pending requests” (see highlighted frame; also corresponds to FIG. 4a) refer to the allocation of floor processing devices 1 to 5 for the floor processing of the respective partial surface areas 9 to 14. The column “type” relates to the kind of floor processing activity to be performed in the respective partial surface area 9 to 14, specifically either a dry cleaning or a wet cleaning, wherein both a dry cleaning and a wet cleaning can also be allocated to one and the same partial surface area 9 to 14. For example, this relates to the partial surface area 10 “living room”, whose wood floor is first to be dry and then wet cleaned. The column “duration” denotes an estimated performance timespan 23 for performing the floor processing activity in the respective partial surface area 9 to 14 by means of the allocated floor processing device 1 to 5. The three columns “1., 2., 3.” listed on the far right of Table 20 contain an order of priority for the floor processing devices 1 to 5 suitable for performing the floor processing activity in the respective partial surface area 9 to 14, wherein a best suited floor processing device 1 to 5 is at place “1.”, and additionally suitable floor processing devices 1 to 5, for example which can perform the floor processing activity, but possibly only with restrictions, for example, are listed thereafter, specifically in columns “2.” and “3”. With respect to the partial surface areas 10, 13 “living room”, the user has transmitted the floor processing command 17 “clean the living room”. Since the floor processing area 10 has the floor type “wood floor”, both a dry cleaning then followed by a wet cleaning can be performed in this partial surface area 10. The partial surface area 13 with the floor type “carpet” is only provided for dry cleaning. The floor processing devices 2 and 1 are here planned for use in dry cleaning operations. The floor processing device 4 (mopping robot) is intended for wet cleaning.

FIGS. 4a to e show the separately framed section of Table 20 at various times in a planning process for the floor processing activities of the floor processing devices 1 to 5. This will be discussed in more detail below.

According to the exemplary embodiment shown only as an example, the invention functions in such a way that the user transmits his or her floor processing commands 17 to the computing device 6 by means of the terminal 25, as explained. The computing device 6 thereupon generates Table 20 from the shared area map 8 of the floor processing devices 1 to 5, along with the indications contained in the floor processing commands 17. In the exemplary embodiment shown, the user specifies concrete rooms with the floor processing commands 17. However, it can alternatively also be provided that the user voice more generally formulated floor processing commands, for example “clean all hard floors”, so that the computing device 6 would determine all partial surface areas 9 to 14 that have a hard floor. To this end, the computing device 6 filters both a partial area designation 15 and a floor type designation 16 out of the floor processing command 17. The same holds true for the type of floor processing activity, here specifically contained in the requests “clean”, “vacuum”, and “mop”.

Table 20 generated by the computing device 6 is used to coordinate floor processing activities of the plurality of floor processing devices 1 to 5 present in the system. The allocation of a specific floor processing device 1 to 5 to a floor processing activity in a specific partial area 9 to 14 takes place via a sorting algorithm executed by the computing device 6, which considers various device parameters of the floor processing devices 1 to 5, along with their current positions in relation to the partial surface area 9 to 14 to be processed. In particular, it makes sense to examine the current position of the floor processing devices 1 to 5 in relation to the location of the partial surface areas 9 to 14 to be processed. For example, the floor processing devices 1 to 5 are here not designed to move from one floor 18 to the other floor 19 and vice versa. Therefore, exclusively the floor processing devices 1, 2 and 4 located on floor 18 can be used for floor processing activities that relate to a partial surface area 9, 10, 11, 13 on floor 18. The same holds true for the floor processing devices 3 and 5, which are located on the other floor 19 with the partial surface areas 12, 14. In the following, the sorting algorithm which initiates the entries on Table 20 relating to the selection of floor processing devices 1 to 5 will be described in more detail. The shared area map 8 comprises the essential foundation for the information contained on Table 20. For example, it discloses the floor type designation 16 and surface information 30 along with the contamination information 21. For example, the user here also enters the respective partial area designation 15 and the floor 18, 19 in the area map 8 or directly on Table 20.

In the exemplary embodiment shown, the floor processing command 17 contains information about which partial surface area 9 to 14 is to be cleaned, possibly along with when the cleaning is to be started and/or ended, and what kind of cleaning is to be performed. If one item of information is not on hand, it can be actively requested from the user, for example by way of a request displayed on the terminal 25. Given an inadequately indicated specification, a standard cleaning can alternatively be performed, for which parameters are defined. For example, if the type of cleaning is not indicated, the standard cleaning “dry cleaning” defined for it takes place. The performance time is entered in the field “time specification” 24 and the type of cleaning “dry” and/or “wet” is entered in the field “activity/type” from the floor processing command 17 of the user, if available. To this end, it is here determined that carpets and carpeted floors are only dry cleaned, and hard floors as well as wood floors are both dry and wet cleaned. The corresponding floor processing command 17 is allocated twice to the partial surface area 10 “living room”, specifically once for the floor type 16 “wood floor” and once for the floor type 16 “carpet”. Since both floor processing devices 1, 2 that can perform a dry cleaning are present on the accompanying floor 18, along with a floor processing device 4 that can perform a mopping operation, both a “dry cleaning” and a “wet cleaning” are planned for the floor type 16.

A time specification 24 was entered in the field “pending requests” for cleaning the partial surface areas 12 “bathroom” and 14 “bedroom”. The cleaning of the partial surface area 12 starts at the entered time (7:30 a.m.). Cleaning is performed by the floor processing device 5. The floor processing device 3 is used for cleaning the partial surface area 14 “bedroom”, and is located on the floor 19 “upper floor” along with the partial surface area 14. The feature relative to the partial surface area 14 is that the floor processing activity must have ended by a defined time, here specifically by 7 p.m. To this end, the computing device 6 determines the time at which the floor processing device 3 must begin the floor processing activity so as to meet the requirement. Since a duration of 30 minutes was here calculated as the anticipated performance timespan 23 for the floor processing activity by the floor processing device 3, 6:30 p.m. arises as the starting time for cleaning the bedroom (see FIG. 4e). The required performance timespan 23 is calculated based on the known parameters surface information 30, contamination information 21, as well as on device parameters of the corresponding floor processing device 1 to 5, for example specifically its current accumulator charge status, typical cleaning power, and the like. The estimate for the anticipated performance timespan 23 is indicated in the corresponding column “duration”. This value can additionally be determined from earlier floor processing activities, or based on globally defined empirical values.

The sorting algorithm used by the computing device 6, which determines the order of priority of the floor processing devices 1 to 5 in the last three columns of Table 20, is based on defined rules, which are here processed in the sequence described below, for example.

For example, a first rule stipulates that a specific floor processing devices 1 to 5 be planned for a floor processing activity in a partial surface area 9 to 14 if a path of movement exists between the current position of the floor processing device 1 to 5 and the position of the partial surface area 9 to 14 to be cleaned that can be successfully taken by the floor processing device 1 to 5. A path of movement does not exist in this sense if the partial surface area 9 to 14 and the floor processing device 1 to 5 are not located on the same floor 18, 19, and the floor processing device 1 to 5 is thus unable to move toward the partial surface area 9 to 14. In addition, for example, a path of movement also does not exist if the floor processing device 1 to 5 is a mopping robot that cannot traverse a carpet located in the path of movement.

A second rule of the sorting algorithm can stipulate that all those floor processing devices 1 to 5 be precluded from performing a specific floor processing activity that do not satisfy the specification of the activity type, for example specifically “dry cleaning” or “wet cleaning”. As a consequence, a mopping robot cannot be used for a dry cleaning, and a vacuum cleaner cannot be used for a wet cleaning.

For example, another rule here provides that the floor processing devices 1 to 5 planned in the three right columns of Table 20 be sorted with respect to an order of priority according to a distance to the partial surface area 9 to 14 to be processed, the size of the partial surface area 9 to 14, the contamination of the partial surface area 9 to 14, and the charge status of an accumulator of the respective floor processing device 1 to 5.

In summation, the order of priority that denotes the suitability of a floor processing device 1 to 5 for a specific floor processing activity is established as a function of the device parameters of the floor processing devices 1 to 5 as well as the spatial conditions of the partial surface areas 9 to 14.

In particular, for example, a ratio “Ki” is calculated, which depends on the distance “Di” between the floor processing devices and the partial surface area 9 to 14 to be processed, as well as on a surface variable “Ci” and a contamination variable “Pi”. The ratio is here calculated according to the formula

Ki=Di/max(Di,i)+Ci/max(Ci,i)+Pi/max(Pi,i).

The variable “Ci” is here derived as exp(Ad1−A). The variable “Pi” is derived as exp(A*S−V1*F1). “Ci” describes the correlation between the cleaning surface “A” and an estimated surface “Adi”, which the robot can clean with a current accumulator charge. As a result of this variable, preference is given to floor processing devices 1 to 5 for cleaning a partial surface area 9 to 14 that are able to completely process the partial surface area 9 to 14 with their current accumulator charge. The variable “Pi” describes the correlation between the contamination “S” of the partial surface area 9 to 14 (recorded on Table 20 as contamination information 21) and the fill level “V” of the dirt container of the floor processing device 1 to 5. F describes a parameter that indicates the maximum amount of dirt the dirt container can hold. The exponential function “exp” used here is only an exemplary function, which can be used for sorting the floor processing devices 1 to 5. As a result, the floor processing device 1 to 5 with the smallest ratio “Ki” can best perform the floor processing activity.

Based on the queue on Table 20 defined by the order of priority for the floor processing devices 1 to 5 (the three last columns on Table 20 listed on the right), the floor processing devices 1 to 5 are controlled for planned floor processing operations. As explained above, the floor processing devices 1 to 5 are allocated to specific floor processing activities in the partial surface areas 9 to 14 based on their suitability. FIGS. 3 and 4a show the initial state of planning on Table 20. On FIG. 4b, a cleaning task for the partial surface area 13 was assigned to the floor processing device 2, and the floor processing device 2 was correspondingly deleted from all queues on Table 20. On FIG. 4c, the floor processing device 1 was allocated to dry cleaning the partial surface area 10, and removed from all other queues. On FIG. 4d, the floor processing device 4 was allocated to wet cleaning the partial surface area 10, and removed from the other queues, so that there are no further floor processing devices 1 to 5 on the floor 18 (ground floor) that are currently available for a floor processing activity. On FIG. 4e, the time specification 24 for the pending requests was allocated to the floor processing activities for the partial surface areas 12 and 14. However, the floor processing devices 3 and 5 are only allocated to a floor processing activity on Table 20 if the corresponding floor processing activity is actually started.

The floor processing devices 1 to 5 are preferably sorted in the order of priority/queue in such a way that a partial surface area 9 to 14 cannot be processed if the column “1.” contains no floor processing device 1 to 5 for this partial surface area 9 to 14. In concrete terms, this then means that all available floor processing devices 1 to 5 are already busy with other floor processing activities. If a partial surface area 9 to 14 is to be both dry and wet cleaned, a dry cleaning by one of the floor processing devices 1 to 3 is first planned, and only after that a wet cleaning by one of the floor processing devices 4 and 5. The floor processing devices 1 to 5 are here preferably always first allocated to processing hard floors or wood floors, and only thereafter to cleaning carpets or carpeted floors. In a case where both a dry cleaning and a wet cleaning are to be performed, this rule makes it possible to ensure that floor processing devices 1 to 5 are not blocked by the cleaning of carpets or carpeted floors, since this in particular might in turn only allow the delayed use of the wet cleaning devices planned for the hard floors or wood floors. In addition, it is preferably proposed that Table 20 be processed in terms of time from the top down according to the sequence of listed partial surface areas 9 to 14. As a consequence, a preferred processing of a specific partial area 9 to 14 can be achieved by placing the corresponding partial surface area 9 to 14 in the top line on Table 20.

In the event that a floor processing operation must be started or ended at a defined time, as shown in particular on FIG. 4e, or a time interval is prescribed for cleaning by the user, the computing device 6 must be used to decide when which floor processing device 1 to 5 is available for the floor processing activity. In the present exemplary embodiment, the cleaning of the partial surface area 12 must start by 6:30 p.m. at the latest, so it ends by 7 p.m. as desired by the user. It is important that the floor processing device 5 for processing the partial surface area 12 at the defined time be reserved, specifically in such a way that the floor processing device 5 is available at the starting time (time specification 24), and has a minimum required accumulator charge for successfully performing the floor processing activity. The estimated performance timespan 23 is also used to establish the starting time for the floor processing activity, so that the floor processing activity has also concluded by the desired end time. For example, the performance timespan 23 can be known from earlier floor processing activities, or have been determined in an exploratory trip. In addition, the estimated performance timespan 23 can also be used to directly check whether the floor processing command 17 voiced by the user can actually be implemented.

In the event a desired floor processing activity cannot be performed by a floor processing device 1 to 5, the partial surface area 9 to 14 can be divided into sub-partial areas. Additional lines then arise on Table 20 for the sub-partial area of the partial surface areas 9 to 14. If the user command cannot be executed at all, the user can alternatively be given a suggestion, for example, as to how and in what way the respective partial surface area 9 to 14 can still be processed.

Even though not illustrated here, the user can of course still transmit many other floor processing commands 17 to the computing device 6 of the system. Additional examples include commands like “clean all carpets on the ground floor”, “clean all hard floors”, “clean all rooms that are very dirty”, and others.

Although only a few embodiments of the present invention have been shown and described, it is to be understood that many changes and modifications may be made thereunto without departing from the spirit and scope of the invention.

### REFERENCE LIST

1 Floor processing device
2 Floor processing device
3 Floor processing device
4 Floor processing device
5 Floor processing device
6 Computing device
7 Database
8 Area map
9 Partial surface area
10 Partial surface area
11 Partial surface area
12 Partial surface area
13 Partial surface area
14 Partial surface area
15 Partial area designation
16 Floor type designation
17 Floor processing command
18 Floor
19 Floor
20 Table
21 Contamination information
22 Time specification
23 Performance timespan
24 Time specification
25 Terminal
26 Wheel
27 Brush
28 Mopping element
29 Navigation and self-localization system
30 Surface information

What is claimed is:

1. A system for the automatically controlled processing of a surface in an environment, comprising:
at least two automatically moving floor processing devices,
a shared computing device allocated to the floor processing devices, the shared computing device being configured to plan at least one operational activity of at least one floor processing device based on defined rules, and
a shared database allocated to the floor processing devices, the shared database storing an area map with several partial surface areas and the planned operational activity, as well as a partial area designation and/or a floor type designation associated with the partial surface areas,
wherein the computing device is set up to receive a floor processing command from a user of the system, the floor processing command indicating a floor processing activity to be performed, and having a partial area designation and/or a floor type designation,
wherein the computing device is set up to ascertain the partial surface areas out of the plurality of partial surface areas contained in the area map that correspond to the partial area designation and/or floor type designation specified in the floor processing command, and according to predefined rules to plan a performance of the floor processing activity specified in the floor processing command by at least one of the floor processing devices, wherein the rules depend on a device parameter of the floor processing device and a position of the partial surface area in the environment to be processed.

2. The system according to claim 1, wherein the floor processing command is a request comprised of several words, wherein the computing device is set up to derive from the floor processing command the indicated floor processing activity and the partial area designation and/or the floor type designation, and a point in time relating to the floor processing operation.

3. The system according to claim 1, wherein the device parameter of the floor processing device is a floor processing element designed for a defined floor processing activity, a device variable, a charge status of an accumulator, a power level of an electric motor, a storage capacity of a collection container and/or a range, traveling speed or climbing ability of the floor processing device.

4. The system according to claim 1, wherein the floor processing device specified for performing the floor processing activity is selected as a function of a distance and/or a height difference between a location of the partial surface area to be processed and a current position of the floor processing device.

5. The system according to claim 1, wherein the database of the system has information about the partial surface areas of the environment, in the form of a partial area designation, floor information relating to a floor of a building having the partial surface area, a floor type designation and/or a surface size of the partial surface area.

6. The system according to claim 1, wherein the database contains contamination information for the partial surface area and/or a time specification for a floor processing activity performed last in the partial surface area and/or a time specification for a planned floor processing activity and/or an estimated performance timespan for performing a floor processing activity and/or information about the type of floor processing activity allocated to the partial surface area.

7. The system according to claim 1, wherein the database contains one or several floor processing activities chronologically planned in advance for one or several floor processing devices and allocated to the partial surface areas.

8. The system according to claim 1, wherein the computing device is set up to allocate the floor processing device to a partial surface area based upon a ratio determined according to mathematical methods, which indicates a suitability of the floor processing device for performing the floor processing activity in the partial surface area.

9. The system according to claim 8, wherein several floor processing devices are allocated to a specific partial surface area in the database based on an order of priority, wherein the floor processing devices are planned for processing the same partial surface area as a function of the ratios allocated to the floor processing devices.

10. A method for operating a system configured according to claim 1, comprising the steps of inputting the command from the user into the computing device, and performing the floor processing activity by at least one of the floor processing devices according to the predefined rules.
